(19) United States
(12) Patent Application Publication
(10) Pub. No.: US 2025/0296364 A1
(43) Pub. Date: Sep. 25, 2025

(54) TAPPING DEVICE, POST-PROCESSING APPARATUS, AND IMAGE FORMING APPARATUS

(71) Applicant: FUJIFILM Business Innovation Corp., Tokyo (JP)

(72) Inventors: Koji KAWANO, Kanagawa (JP); Eri FUKUI, Kanagawa (JP); Yuki MIZUNO, Kanagawa (JP)

(73) Assignee: FUJIFILM Business Innovation Corp., Tokyo (JP)

(21) Appl. No.: 18/766,573

(22) Filed: Jul. 8, 2024

(30) Foreign Application Priority Data
Mar. 19, 2024 (JP) 2024-043976

(51) Int. Cl. B41J 11/42; B41J 13/00

(52) U.S. Cl. CPC B41J 11/42; B41J 13/0009

(57) ABSTRACT

A tapping device includes a contact unit that comes into contact with a medium from one side of a crossing direction that crosses a transport direction of the medium; an approaching and separation unit that approaches and is separated from the contact unit in the crossing direction; and a displacement unit that is supported by the approaching and separation unit via a bias unit, at each of positions shifted from each other in the transport direction to be displaceable in the crossing direction, and taps the medium in contact with the contact unit from the other side of the crossing direction by the approaching and separation unit approaching the contact unit.

### CROSS-REFERENCE TO RELATED APPLICATIONS

This application is based on and claims priority under 35 USC 119 from Japanese Patent Application No. 2024-043976 filed Mar. 19, 2024.

### BACKGROUND

### (i) Technical Field

The present disclosure relates to a tapping device, a post-processing apparatus, and an image forming apparatus.

### (ii) Related Art

JP2005-219885A discloses a sheet post-processing apparatus including a sheet aligning member that is movable to align end portions of a plurality of sheets placed on an aligning tray in a state in which the plurality of sheets are placed on the aligning tray, in which an end portion of the sheet is prevented from being caught on at least one of an end portion of the sheet aligning member or a movement path of the sheet aligning member, and at least one of the end portion of the sheet aligning member or a peripheral edge of the sheet aligning member in the movement path is formed to be lower than a surface of the aligning tray.

JP2003-002519A discloses a sheet post-processing apparatus in an image forming apparatus including an intermediate tray in which sheets are carried in one by one from the image forming apparatus, and the sheets are once aligned into a bundle by a sheet end portion alignment unit and then stored for post-processing such as stapling, in which the sheet end portion alignment unit includes an offset mechanism that offsets the sheet bundle in a direction orthogonal to a sheet feeding direction in a case where the sheets are discharged from the intermediate tray to a sheet loading tray.

### SUMMARY

A tapping device is considered which includes a contact unit that comes into contact with a medium from one side in a crossing direction crossing a transport direction of the medium, an approaching and separation unit that approaches and is separated from the contact unit in the crossing direction, and a displacement unit that is supported by the approaching and separation unit via a bias unit to be displaceable in the crossing direction and taps the medium in contact with the contact unit from the other side of the crossing direction by the approaching and separation unit approaching the contact unit.

In the tapping device, in a case where a single displacement unit is supported by the approaching and separation unit via the bias unit, the misalignment of the medium may occur depending on the length of the medium.

Aspects of non-limiting embodiments of the present disclosure relate to a tapping device, a post-processing apparatus, and an image forming apparatus that suppress misalignment of a medium regardless of a length of the medium as compared with a case where a single displacement unit is supported by the approaching and separation unit via a bias unit.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a tapping device including a contact unit that comes into contact with a medium from one side of a crossing direction that crosses a transport direction of the medium; an approaching and separation unit that approaches and is separated from the contact unit in the crossing direction; and a displacement unit that is supported by the approaching and separation unit via a bias unit, at each of positions shifted from each other in the transport direction to be displaceable in the crossing direction, and taps the medium in contact with the contact unit from the other side of the crossing direction by the approaching and separation unit approaching the contact unit.

### BRIEF DESCRIPTION OF THE DRAWINGS

Exemplary embodiment(s) of the present invention will be described in detail based on the following figures, wherein:

FIG. 1 is a front view illustrating an entire outline of an image forming system of the present disclosure;

FIG. 2 is a side sectional view of an aligning unit of a first exemplary embodiment;

FIG. 3 is a side sectional view of a state in which a displacement unit is in contact with the other side of a recording medium in the aligning unit of the first exemplary embodiment;

FIG. 4 is a side sectional view of a state in which a displacement unit is in contact with the other side of another recording medium in the aligning unit of the first exemplary embodiment;

FIG. 5 is a diagram in a state where the displacement unit is in contact with the other side of the recording medium as viewed from the contact unit side;

FIG. 6 is a side sectional view of an aligning unit of a second exemplary embodiment; and

FIG. 7 is a plan sectional view of an aligning unit of a third exemplary embodiment.

### DETAILED DESCRIPTION

### Configuration of First Exemplary Embodiment

Hereinafter, an example of exemplary embodiments of the present disclosure will be described with reference to the drawings.

### Image Forming System

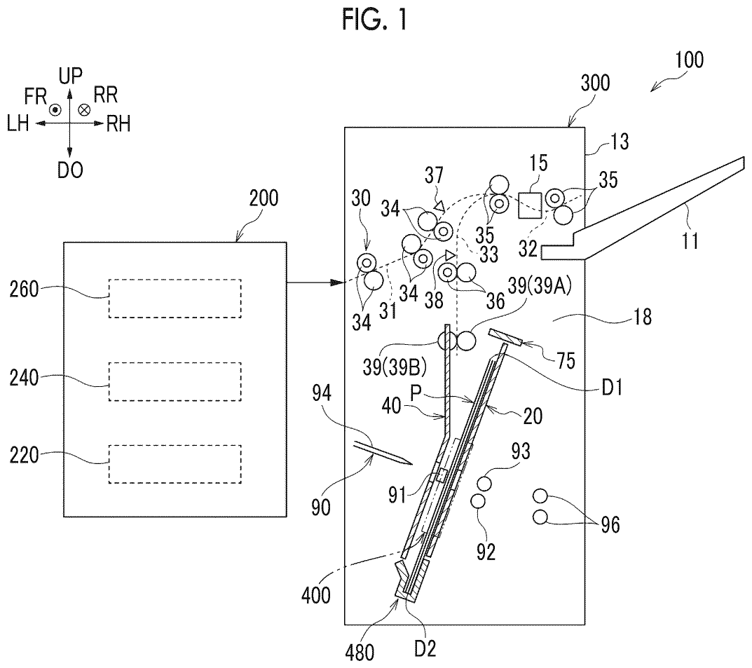

First, a configuration of an image forming system 100 according to the present exemplary embodiment will be described. FIG. 1 is a schematic view illustrating a configuration of the image forming system 100 according to the present exemplary embodiment.

Note that an arrow UP illustrated in the drawings indicates an upper side of the image forming system, and an arrow DO indicates a lower side of the image forming system. In addition, an arrow LH illustrated in the drawings indicates a left side of the image forming system, and an arrow RH indicates a right side of the image forming system. In addition, an arrow FR illustrated in the drawings indicates a front side of the image forming system, and an arrow RR indicates a rear side of the image forming system. Since these directions are the directions defined for convenience of description, the system configuration is not limited to these directions. Note that, in each direction of the image forming system, the term “image forming system” may be omitted. That is, for example, “upper side of the image forming system” may be simply represented as “upper side”.

In addition, in the following description, a term “up-down direction” may be used to mean “both of an upward direction and a downward direction” or “any one of the upward direction or the downward direction”. A term “left-right direction” may be used to mean “both of a rightward direction and a leftward direction” or “any one of the rightward direction or the leftward direction”. Note that the “left-right direction” may also be referred to as a lateral direction, a transverse direction, and a horizontal direction. A term “front-rear direction” may be used to mean “both of a forward direction and a rearward direction” or “any one of the forward direction or the rearward direction”. Note that the “front-rear direction” may also be referred to as a lateral direction, a transverse direction, and a horizontal direction. In addition, the up-down direction, the left-right direction, and the front-rear direction are directions that cross each other (specifically, directions orthogonal to each other).

In addition, a symbol in which “x” is in “○” in the drawings means an arrow from the front to the back of the sheet surface. In addition, a symbol in which “⋅” is in “○” in the drawings means an arrow from the back to the front of the sheet surface. In addition, dimensional ratios of parts illustrated in the respective drawings in the up-down direction, the left-right direction, and the front-rear direction may differ from actual dimensional ratios.

The image forming system 100 illustrated in FIG. 1 is a system that forms an image on a recording medium P, and includes an image forming apparatus 200 and a post-processing apparatus 300. Hereinafter, each unit (specifically, the image forming apparatus 200 and the post-processing apparatus 300) of the image forming system 100 will be described.

### Image Forming Apparatus

The image forming apparatus 200 is an apparatus that forms an image on the recording medium P. The image forming apparatus 200 includes a paper feeding unit 220, an image forming unit 240, and a discharge unit 260. As the image forming apparatus 200, for example, an electrophotographic image forming apparatus that forms an image on the recording medium P using a toner is used.

The paper feeding unit 220 performs, for example, a step of supplying the recording medium P.

The image forming unit 240 performs, for example, each step of charging, exposure, development, transfer to the recording medium P, and fixing.

For example, in a case where there are a step of discharging or the like of the recording medium P on which the image is formed and a step of post-processing after the discharge, the discharge unit 260 performs each step of supplying or the like of the recording medium P to the post-processing apparatus 300.

In addition, the image forming apparatus 200 is not limited to the above-described electrophotographic image forming apparatus 200, and for example, an ink jet image forming apparatus 200 may be used or various image forming apparatuses 200 can be used. In the ink jet image forming apparatus 200, for example, ink droplets are jetted from a jetting unit (not illustrated) to the recording medium P to form an image on the recording medium P.

### Post-Processing Apparatus

The post-processing apparatus 300 illustrated in FIG. 1 is an apparatus that executes post-processing on the recording medium P on which an image is formed by the image forming apparatus 200. Specifically, as illustrated in FIG. 1, the post-processing apparatus 300 includes a post-processing apparatus main body 13, a discharge unit 11, a first post-processing unit 15, a transport mechanism 30, a pre-processing unit 18, and a second post-processing unit 90. Hereinafter, each unit of the post-processing apparatus 300, specifically, the post-processing apparatus main body 13, the discharge unit 11, the first post-processing unit 15, the transport mechanism 30, the pre-processing unit 18, and the second post-processing unit 90 will be described.

### Post-Processing Apparatus Main Body 13, Discharge Unit 11, and First Post-Processing Unit 15

The post-processing apparatus main body 13 illustrated in FIG. 1 is a part in which each constituent unit of the post-processing apparatus 300 is provided. Specifically, the post-processing apparatus main body 13 is configured by a housing formed in a box-like shape (for example, a substantially rectangular parallelepiped shape).

In the present exemplary embodiment, as illustrated in FIG. 1, for example, the first post-processing unit 15, the transport mechanism 30, the pre-processing unit 18, and the second post-processing unit 90 are provided inside the post-processing apparatus main body 13. The discharge unit 11 is provided on a right side surface of the post-processing apparatus main body 13.

The discharge unit 11 is disposed at an upper portion on the right side surface of the post-processing apparatus main body 13. The recording medium P on which the post-processing has been executed by the first post-processing unit 15 is discharged to the discharge unit 11.

Here, the post-processing is processing executed on the recording medium P on which the image is formed. As the post-processing executed by the first post-processing unit 15, there is binding processing of binding a plurality of recording media P with a stapler. Note that the post-processing is not limited to the binding processing. The post-processing may be, for example, cutting processing of cutting the recording medium P, drilling processing of making a hole in the recording medium P, or the like, and may be processing executed on the recording medium P on which an image is formed.

### Transport Mechanism 30

As illustrated in FIG. 1, the transport mechanism 30 is a mechanism that transports the recording medium P to the discharge unit 11 or the pre-processing unit 18 described below. Specifically, the transport mechanism 30 includes a first path 31, a second path 32, a third path 33, transport rolls 34, 35, and 36, a first detection unit 37, a second detection unit 38, and a transport roll 39. In a case where the recording medium P is transported to the discharge unit 11, the transport mechanism 30 transports the recording medium P passing through the first path 31 to the discharge unit 11 by the forward rotation of the transport roll 35 of the second path 32. On the other hand, in a case where the recording medium P is transported to the pre-processing unit 18, the transport mechanism 30 transports the recording medium P passing through the first path 31 to the pre-processing unit 18 side by the reverse rotation of the transport roll 35 of the second path 32.

The third path 33 is a transport path for transporting the recording medium P from the second path 32. The transport roll 36 and the second detection unit 38 are disposed in the third path 33. The second detection unit 38 detects an end portion (for example, a distal end portion) of the recording medium P transported through the third path 33.

A plurality of transport rolls 36 are capable of performing the forward rotation and the reverse rotation, and the recording medium P can be switched back in the third path 33. In a case where the plurality of transport rolls 36 perform the forward rotation, the recording medium P is transported to the pre-processing unit 18 described below.

In addition, by the reverse rotation of the transport roll 36, the recording medium P switched back in the third path 33 is transported to the second path 32. The transport roll 36 is capable of controlling a transportation speed of the recording medium P. In addition, the transport roll 36 is capable of controlling the transportation timing at which the recording medium P is transported to the second path 32, on the basis of a detection result of the second detection unit 38.

In the transport mechanism 30, the recording medium P transported from the image forming apparatus 200 in the order of the first path 31, the second path 32, and the third path 33 is transported to the pre-processing unit 18.

The transport roll 39 is a constituent unit that transports each of the plurality of recording media P transported from the transport mechanism 30.

In the present exemplary embodiment, the transport roll 39 transports the recording medium P to the lower side. Specifically, the transport roll 39 includes a driving roll 39A and a driven roll 39B, and transports the recording medium P with the pair of rolls sandwiching the recording medium P. The driving roll 39A is disposed to be close to the discharge unit 11 side (on the right side in the present exemplary embodiment) with respect to the driven roll 39B. The driven roll 39B is disposed on a side opposite to the discharge unit 11 (on the left side, in the present exemplary embodiment) with respect to the driving roll 39A.

### Pre-Processing Unit 18

The pre-processing unit 18 performs pre-processing on the recording medium P transported by the transport mechanism 30. The pre-processing refers to aligning the orientation of the plurality of recording media P in the up-down direction and the front-rear direction before the processing by the post-processing unit. The pre-processing unit 18 includes a loading unit 20, a guide unit 40, a support unit 480, an abutting unit 75, and an aligning unit 400.

### Loading Unit 20

As illustrated in FIG. 1, the loading unit 20 loads the recording medium P. In the present exemplary embodiment, the loading unit 20 has a plate-like body extending obliquely upward (in the present exemplary embodiment, obliquely upward to the right) in a plan view. The loading unit 20 has a loading surface directed obliquely upward (in the present exemplary embodiment, obliquely upward to the left), and is provided at a position facing a lower portion of the transport roll 39. In the loading unit 20, the recording medium P to which a transporting force is applied by the transport roll 39 is loaded on the loading surface in a state where one end (hereinafter, referred to as a lower end D2) of the recording medium P is directed downward. In the loading unit 20, a through-hole (not illustrated) through which a knife 94 passes is formed.

### Guide Unit 40

As illustrated in FIG. 1, the guide unit 40 is a constituent unit that guides the recording medium P transported by the transport roll 39. In the present exemplary embodiment, the guide unit 40 has a plate-like body extending obliquely upward (in the present exemplary embodiment, obliquely upward to the right). The guide unit 40 has a guiding surface that is directed obliquely downward (in the present exemplary embodiment, obliquely downward to the right) and faces the loading surface of the loading unit 20. In the guide unit 40, the recording medium P is guided to the loading surface of the loading unit 20 by the guiding surface. In the guide unit 40, a through-hole (not illustrated) through which the knife 94 passes is formed.

### Support Unit 480

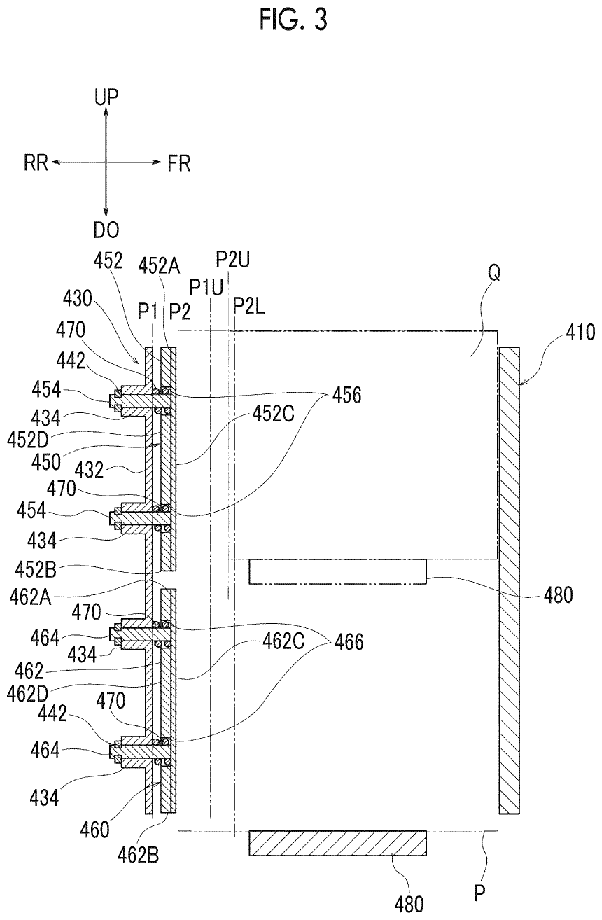

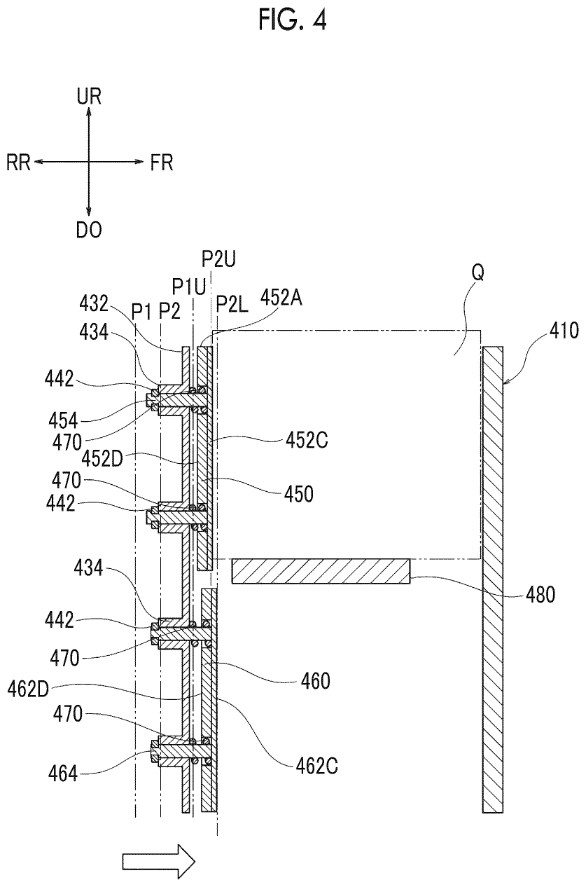

As illustrated in FIG. 1, the support unit 480 is a constituent unit that supports the lower end D2 of the recording medium P loaded on the loading surface of the loading unit 20. The support unit 480 is disposed obliquely downward to the left with respect to the loading unit 20. The lower ends D2 of the plurality of recording media P loaded on the loading surface of the loading unit 20 abut against the support units 480, and thus the lower ends D2 are aligned with each other. In addition, as illustrated in FIGS. 3 and 4, the support unit 480 can be moved in the up-down direction in accordance with the size of the recording medium. In the present exemplary embodiment, in addition to the recording medium P, a recording medium Q is used. The recording medium Q has a shape shorter than the recording medium P in the front-rear direction and the up-down direction, for example. In a case where the recording medium Q is used, the support unit 480 is moved upward in the up-down direction, and supports the lower end of the recording medium Q.

### Abutting Unit 75

As illustrated in FIG. 1, the abutting unit 75 pushes an upper end D1 of the recording medium P downward to cause the lower end D2 to abut against the support unit 480. As a result, the upper end D1 of the recording medium P (in other words, the position of the recording medium P in the up-down direction) is aligned. Note that the upper end DI is an end portion of the recording medium P on a side opposite to the lower end D2.

In the present exemplary embodiment, the abutting unit 75 is moved from a non-contact position (not illustrated) at which there is no contact with the recording medium P loaded on the loading surface of the loading unit 20, and pushes the upper end DI of the recording medium P downward. The non-contact position is also a position at which the abutting unit 75 is separated from the transport path of the recording medium P transported to the loading surface. In addition, the abutting unit 75 returns to the non-contact position after the lower end D2 of the recording medium P abuts against the support unit 480.

### Aligning Unit 400

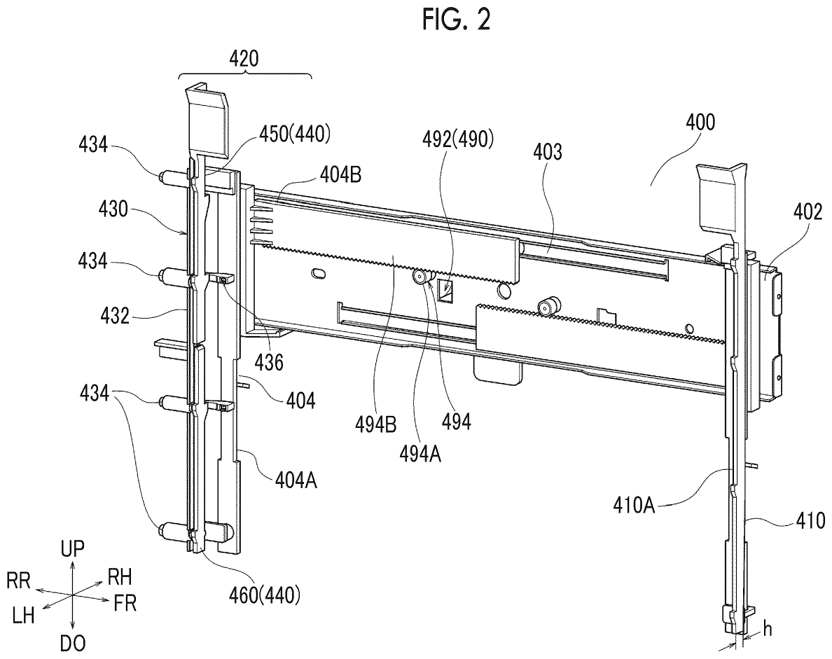

The aligning unit 400 is a constituent unit that aligns a side end portion of the recording medium Pin a state where the surface portion of the recording medium P is loaded on the loading unit 20 and the lower end D2 of the recording medium P is loaded on the support unit 480, and is disposed below the transport roll 39. The aligning unit 400 is an example of the tapping device. As illustrated in FIG. 2, the aligning unit 400 includes a panel 402, a bracket 404, a contact unit 410, and a tapping unit 420. The up-down direction is an example of a transport direction of the medium.

The panel 402 has a rectangular plate-like body extending in the front-rear direction, and is disposed on a back surface side of the loading unit 20. The front-rear direction is an example of a crossing direction. The panel 402 has an opening portion 403. The opening portion 403 is a long hole extending in the front-rear direction, and is a through-hole penetrating in a thickness direction (left-right direction) of the panel 402.

As illustrated in FIG. 2, the bracket 404 has an L-shape configuration including a body portion 404A extending in the up-down direction and a branch portion 404B fixed to an upper end side of the body portion 404A and extending in the front-rear direction. In the bracket 404, the branch portion 404B is positioned on an upper end side of the panel 402, and the body portion is positioned on a rear end side of the panel 402. A part of the branch portion 404B is slidably inserted into the opening portion 403, and the branch portion 404B is guided by an edge of the opening portion 403 in the panel 402, so that the bracket 404 can be reciprocally moved in the front-rear direction with respect to the panel 402. In addition, the aligning unit 400 includes a moving unit 490 that reciprocally moves the bracket 404 in the front-rear direction with respect to the panel 402. The moving unit 490 includes, as main portions, a driving unit 492 fixed to a back surface of the panel 402 and a conversion unit 494 that converts a rotational motion of the driving unit 492 into a reciprocating motion in the front-rear direction. In the present exemplary embodiment, the conversion unit 494 is configured with a pinion 494A mounted on a rotation shaft of a motor as the driving unit 492 and a rack 494B formed in the branch portion 404B and meshing with the pinion 494A.

The contact unit 410 is a long plate-like body that extends in the up-down direction and is fixed to the panel 402. The contact unit 410 has a flat contact surface 410A directed rearward in the front-rear direction. The contact surface 410A comes into contact with the side end portion of the recording medium P loaded in the loading unit 20. The contact unit 410 has a predetermined height h in the left-right direction. For example, the height of the contact unit 410 in the left-right direction is a height with a margin for the thickness of the recording medium P in the number of sheets that can be loaded in the loading unit 20.

### Tapping Unit

The tapping unit 420 has a long configuration that extends in the up-down direction and is movable in the front-rear direction in a state of being supported by the bracket 404. The tapping unit 420 taps the side end portion of the recording medium P. The tapping unit 420 includes an approaching and separation unit 430 and a displacement unit 440. Here, the term “tap” means repeatedly coming into contact with a target surface from a certain direction.

### Approaching and Separation Unit

As illustrated in FIG. 2, the approaching and separation unit 430 has a configuration in which a plurality of cylindrical bodies extending in the front-rear direction are fixed to a long plate-like body extending in the up-down direction. The approaching and separation unit 430 is an example of an operation unit. The approaching and separation unit 430 approaches and is separated from the contact unit 410 in the front-rear direction. Specifically, the approaching and separation unit 430 is fixed to the bracket 404, and approaches and is separated from the contact surface 410A of the contact unit 410 in the front-rear direction in conjunction with the reciprocating motion of the bracket 404 in the front-rear direction due to the rotational motion of the driving unit 492. The approaching and separation unit 430 includes a plate-like portion 432 and a tubular portion 434.

The plate-like portion 432 is a long plate-like body extending in the up-down direction, and is a body of the approaching and separation unit 430. The plate-like portion 432 is disposed behind the body portion 404A of the bracket 404 in the front-rear direction. The plate-like portion 432 includes a fixing portion 436. In the present exemplary embodiment, the plate-like portion 432 includes four fixing portions 436. The fixing portion 436 protrudes forward from the body portion 404A of the bracket 404 in the front-rear direction. By fixing the fixing portion 436 to the body portion 404A of the bracket 404, the plate-like portion 432 can be moved together with the bracket 404.

As illustrated in FIG. 3, the tubular portion 434 is a cylindrical body that protrudes rearward in the front-rear direction from the front end of the plate-like portion 432 in the front-rear direction, and a plurality of the tubular portions 434 are arranged in a row by being spaced from each other in the up-down direction of the plate-like portion 432. The tubular portion 434 and the plate-like portion 432 are integrally formed, and a through-hole shared with the plate-like portion 432 is formed in a hollow portion of the tubular portion 434. That is, in the approaching and separation unit 430, a through-hole extending in the front-rear direction is formed at a position where the tubular portion 434 is disposed. In the present exemplary embodiment, four tubular portions 434 are disposed in a state of being spaced from each other in the up-down direction.

### Displacement Unit

As illustrated in FIG. 2, the displacement unit 440 has a configuration in which a rod-like portion extends in the front-rear direction from a long plate-like portion extending in the up-down direction. The displacement unit 440 is a member that taps the side end portion of the recording medium P from the opposite side of the contact unit 410. The displacement unit 440 includes a first displacement unit 450 and a second displacement unit 460.

Note that since the first displacement unit 450 has the identical basic configuration as the second displacement unit 460, the first displacement unit 450 will be described first, and then the configuration unique to the second displacement unit 460 will be described.

The first displacement unit 450 is disposed on the upper side of the approaching and separation unit 430 in the up-down direction, and taps the upper side of the recording medium P or the side end portion of the recording medium Q loaded in the loading unit 20.

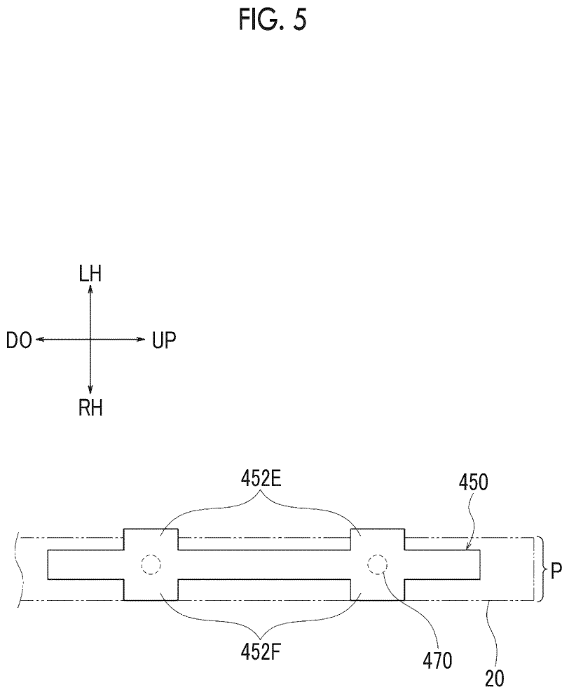

As illustrated in FIGS. 3 and 5, the first displacement unit 450 includes a first flat plate portion 452 and a first rod-like portion 454. The first rod-like portion 454 is an example of a shaft. As illustrated in FIG. 3, the first flat plate portion 452 has a configuration in which a plurality of annular grooves 456 that are open rearward in the front-rear direction are formed at positions spaced from each other in the up-down direction, in a long plate extending in the up-down direction. The first flat plate portion 452 has one end portion 452A, the other end portion 452B, a front end portion 452C, and a rear end portion 452D, and as illustrated in FIG. 5, has a first protruding portion 452E and a second protruding portion 452F.

The one end portion 452A is an upper end portion in the up-down direction. The other end portion 452B is a lower end portion in the up-down direction, and constitutes an end portion on a side opposite to the one end portion 452A. The front end portion 452C is a surface portion that is formed flat and faces the contact unit 410. The rear end portion 452D is a surface portion on a side opposite to the front end portion 452C, and the annular groove 456 that is open rearward in the front-rear direction is formed.

As illustrated in FIG. 5, the first protruding portions 452E are protrusions that protrude to the left side in the left-right direction (the upper side in the up-down direction in the drawing) from the body portion extending in the up-down direction in a state of being spaced from each other in the up-down direction (the left-right direction in the drawing). The second protruding portions 452F are protrusions that protrude to the right side in the left-right direction (the lower side in the up-down direction in the drawing) from the body portion in a state of being spaced from each other in the up-down direction (the left-right direction in the drawing). The protrusion amounts of both of the first protruding portion 452E and the second protruding portion 452F are determined in accordance with the number of recording media P that can be loaded in the loading unit 20.

The first rod-like portion 454 has a rod shape having a center shared with the annular groove 456, extends rearward in the front-rear direction from the rear end portion 452D of the first flat plate portion 452, and has a groove formed on an outer periphery on a rear end side in the front-rear direction. Note that a retaining ring 442 to be described later is attached to the groove. The first rod-like portion 454 is disposed corresponding to the tubular portion 434 of the approaching and separation unit 430. The first rod-like portion 454 has a length in the front-rear direction (height of the cylindrical body) longer than the length of the tubular portion 434 in the front-rear direction, and an outer diameter smaller than an inner diameter of the hollow portion of the tubular portion 434. In the present exemplary embodiment, the first rod-like portion 454 is formed integrally with the first flat plate portion 452.

As illustrated in FIG. 3, a coil spring 470 is a compression coil spring having an inner diameter greater than the outer diameter of the first rod-like portion 454 and an outer diameter greater than a hole diameter of the through-hole of the tubular portion 434 of the approaching and separation unit 430. The coil spring 470 is disposed between the approaching and separation unit 430 and the first flat plate portion 452 of the first displacement unit 450, and biases the first displacement unit 450 with respect to the approaching and separation unit 430. The coil spring 470 is an example of a bias unit. The coil spring 470 is positioned such that the front end thereof in the front-rear direction is located in the annular groove 456. In addition, the rear end of the coil spring 470 in the front-rear direction is positioned by being in contact with the front end of the approaching and separation unit 430 in the front-rear direction. In a case where the coil spring 470 is attached to an outer periphery of the first rod-like portion 454 and the retaining ring 442 is attached to the groove of the first rod-like portion 454 in a state where the first rod-like portion 454 is inserted into the tubular portion 434 of the approaching and separation unit 430, the coil spring 470 is held in a compressed and deformed state (initial attachment state). In the present exemplary embodiment, the coil spring 470 is attached to each of the two first rod-like portions 454 of the first displacement unit 450.

With the configuration described above, the first displacement unit 450 is supported by the approaching and separation unit 430 in the front-rear direction via the coil spring 470.

Next, the second displacement unit 460 will be described. The basic configuration of the second displacement unit 460 is equivalent to the first displacement unit 450. As illustrated in FIG. 2, the second displacement unit 460 is disposed on the lower side of the approaching and separation unit 430 in the up-down direction, at a position shifted from the first displacement unit 450 in the up-down direction to be spaced by a distance GP from the first displacement unit 450, and taps the lower side of the recording medium P loaded in the loading unit 20 (refer to FIG. 3). The second displacement unit 460 is not disposed at a position where the side end portion of the recording medium Q is tapped.

The second displacement unit 460 includes a second flat plate portion 462 and a second rod-like portion 464. The second flat plate portion 462, the second rod-like portion 464, and an annular groove 466 correspond to the first flat plate portion 452, the first rod-like portion 454, and the annular groove 456, respectively, and have the same shapes and functions of the first flat plate portion 452, the first rod-like portion 454, and the annular groove 456. The second flat plate portion 462 has one end portion 462A, the other end portion 462B, a front end portion 462C, and a rear end portion 462D. Both the other end portion 462B and the rear end portion 462D have the same shapes and function as the other end portion 452B and the rear end portion 452D, respectively.

In the second displacement unit 460, a taper that faces the upper side in the up-down direction is formed on a corner portion between the one end portion 462A and the front end portion 462C. In addition to the above description, via the coil spring 470 and the retaining ring 442, the second displacement unit 460 is supported by the approaching and separation unit 430 in the front-rear direction via the coil spring 470.

As described above, the tapping unit 420 has the above-described approaching and separation unit 430 and the displacement unit 440.

In addition, with the above description, the aligning unit 400 is configured.

### Second Post-Processing Unit 90

The second post-processing unit 90 illustrated in FIG. 1 is a constituent unit that executes post-processing on the recording medium P loaded on the loading surface of the loading unit 20. The second post-processing unit 90 is an example of a processing unit. In the present exemplary embodiment, the second post-processing unit 90 executes, as the post-processing, processing of binding a plurality of recording media P and folding the plurality of recording media P.

As illustrated in FIG. 1, the second post-processing unit 90 includes a binding unit 91, a pair of folding rolls 92 and 93, the knife 94, and a discharge roll 96. The binding unit 91 is a so-called stapler, and binds a plurality of recording media P by striking a needle at central portions of the plurality of recording media P loaded on the loading surface of the loading unit 20 in the up-down direction.

The pair of folding rolls 92 and 93 is disposed obliquely downward to the right side from the through-hole of the loading surface of the loading unit 20 to be arranged in a row obliquely upward to the right. The folding rolls 92 and 93 are rotated, respectively.

The knife 94 has a length longer than the length of the recording medium P in the front-rear direction, and has a distal end portion formed in a tapered shape that is tapered.

The knife 94 pushes the recording medium P, so that the recording medium P is folded. Specifically, the knife 94 is moved obliquely downward to the right, perpendicular to the guide unit 40, and presses a distal end portion thereof against the central portion of the plurality of recording media P, which is a crease portion, in the up-down direction to push the central portion between the pair of folding rolls 92 and 93, so that the plurality of recording media P are folded by being sandwiched between the pair of folding rolls 92 and 93.

By rotating the pair of folding rolls 92 and 93, the folded recording medium P is transported to the discharge roll 96. Moreover, the discharge roll 96 transports the plurality of recording media P folded by the pair of folding rolls 92 and 93 and the knife 94 to a discharge unit (not illustrated).

Note that the post-processing executed by the second post-processing unit 90 is not limited to the above-mentioned processing. As the post-processing, for example, only one of the binding processing of binding the plurality of recording media P and the folding processing of folding the plurality of recording media P may be performed. In addition, the post-processing may be cutting processing of cutting the recording medium P, drilling processing of making a hole in the recording medium P, or the like, and may be processing executed on the recording medium P on which an image is formed.

### Operation and Effects

In a case where the post-processing is executed by the post-processing apparatus 300, the aligning unit 400 aligns the positions of the recording medium P or Q loaded in the loading unit 20 in the front-rear direction. In the present exemplary embodiment, FIG. 3 illustrates a state where the recording media P are aligned, and FIG. 4 illustrates a state where the recording media Q are aligned. Note that a position P1, a position P2, a position P1U, a position P2U, and a position P2L are all absolute positions with respect to the aligning unit 400, and these are arranged from the rear to the front in the front-rear direction, and are determined in accordance with the size of the recording medium P or Q. Specifically, the position P1 is a position of the approaching and separation unit 430 before the recording medium P is tapped, and the position P2 is a position of the first displacement unit 450 and the second displacement unit 460 before the recording medium P is tapped. In addition, the position P1U is a position of the approaching and separation unit 430 before the recording medium Q is tapped, the position P2U is a position of the first displacement unit 450 before the recording medium Q is tapped, and the position P2L is a position of the second displacement unit 460 in a case where the first displacement unit 450 is positioned at the position P2U.

As illustrated in FIG. 3, in a case where the recording media P are aligned, the recording media P are set along the contact unit 410. Next, the bracket 404 is moved by the driving unit 492 (refer to FIG. 2) such that the approaching and separation unit 430 is positioned at the position P1 and the first displacement unit 450 and the second displacement unit 460 are positioned at the position P2. Moreover, the bracket 404 performs the reciprocating motion in the front-rear direction by the operation of the driving unit 492, and the approaching and separation unit 430 starts the tapping operation. As a result, the approaching and separation unit 430 repeatedly presses the first displacement unit 450 and the second displacement unit 460 against the side end portion of the recording medium P via the coil spring 470, that is, taps the recording medium P. The first displacement unit 450 and the second displacement unit 460 that are repeatedly pressed against the side end portion of the recording medium P align the recording medium P in the front-rear direction while the coil spring 470 is compressed and deformed.

As illustrated in FIG. 4, in a case where the recording media Q are aligned, the recording media Q are set along the contact unit 410. Next, the bracket 404 is moved by the driving unit 492 (refer to FIG. 2) such that the approaching and separation unit 430 is positioned at the position P1U, the first displacement unit 450 is positioned at the position P2U, and the second displacement unit 460 is positioned at the position P2L. Moreover, the bracket 404 performs the reciprocating motion in the front-rear direction by the operation of the driving unit 492, and the approaching and separation unit 430 starts the tapping operation. As a result, the approaching and separation unit 430 repeatedly presses the first displacement unit 450 against the side end portion of the recording medium Q via the coil spring 470, that is, taps the recording medium Q. The first displacement unit 450 that is repeatedly pressed against the side end portion of the recording medium Q aligns the recording medium Q in the front-rear direction while the coil spring 470 is compressed and deformed.

On the other hand, since the recording medium Q has a shorter length in the up-down direction than the recording medium P, the second displacement unit 460 does not come into contact with the recording medium Q. Therefore, the coil spring 470 between the approaching and separation unit 430 and the second displacement unit 460 does not receive a reaction force from the recording medium Q, and repeats the reciprocating motion in the front-rear direction according to the tapping operation of the approaching and separation unit 430 while maintaining the initial attachment state.

In the present exemplary embodiment, as illustrated in FIG. 2, the aligning unit 400 includes the contact unit 410 that comes into contact with the recording medium Q from a front side in the front-rear direction, the approaching and separation unit 430 that approaches and is separated from the contact unit 410 in the front-rear direction, and the displacement units 440 that are supported by the approaching and separation unit 430 via the coil spring 470 to be displaceable in the front-rear direction at positions shifted from each other in the up-down direction, and tap the recording medium in contact with the contact unit 410 from the rear side in the front-rear direction in a case where the approaching and separation unit 430 approaches the contact unit 410.

In other words, the aligning unit 400 includes the contact unit 410 that comes into contact with the recording medium Q from the front side in the front-rear direction, and the tapping unit 420 which taps the recording medium Q in contact with the contact unit 410 from the front side in the front-rear direction, and has the approaching and separation unit 430 that performs the tapping operation and the first displacement unit 450 and the second displacement unit 460 each of which is supported by the operation unit via the coil spring 470 to be displaceable in the front-rear direction and comes into contact with the recording medium Q during the tapping operation, and in which the number of first displacement units 450 and second displacement units 460 that come into contact with the recording medium is different depending on the length in the up-down direction.

With the above configuration, as compared with a case where a single displacement unit having a size capable of tapping the recording medium P from the top to the bottom is supported by the approaching and separation unit via a plurality of bias units spaced from each other in the up-down direction or a case where the single displacement unit taps the recording medium, the misalignment of the recording medium Q is suppressed regardless of the length of the recording medium.

In addition, in the aligning unit 400 according to the present exemplary embodiment, the first displacement unit 450 and the second displacement unit 460 extend in the transport direction (the up-down direction of FIG. 3) of the recording medium, and are supported by the coil springs 470 disposed at positions shifted from each other in the transport direction with respect to the approaching and separation unit 430. With the above configuration, the misalignment of the recording medium is suppressed as compared with a configuration in which the displacement unit is supported by the approaching and separation unit via a single coil spring.

In addition, in the aligning unit 400 according to the present exemplary embodiment, the first displacement unit 450 and the second displacement unit 460 are supported by the common approaching and separation unit 430. With the configuration, the misalignment of the recording medium is suppressed as compared with a configuration in which a plurality of displacement units are independently supported by the approaching and separation unit.

In addition, in the aligning unit 400 according to the present exemplary embodiment, as illustrated in FIG. 2, the approaching and separation unit 430 has the tubular portion 434 formed in a tubular shape extending in the front-rear direction, and the first displacement unit 450 and the second displacement unit 460 have the first rod-like portion 454 inserted into the approaching and separation unit 430 in a state where the first rod-like portion 454 extends to a side separated from the contact unit 410 in the front-rear direction and is attached with the coil spring 470 (refer to FIG. 3) on the outer periphery. With the configuration, as compared with a configuration in which the displacement unit is supported by the approaching and separation unit only via the coil spring, a tapping direction is regulated, and thus the tapping direction by the first displacement unit 450 and the second displacement unit 460 is stable.

In addition, in the aligning unit 400 according to the present exemplary embodiment, the second displacement unit has a taper formed on a corner portion between the one end portion 462A and the front end portion 462C. With the configuration, in a case where the recording medium P is carried into the aligning unit 400, the recording medium is less likely to be caught by the second displacement unit 460 as compared with a configuration having an end portion that is orthogonal to the recording medium and is configured by only a surface along the recording medium.

In addition, in the aligning unit 400 according to the present exemplary embodiment, the displacement unit 440 has the first displacement unit 450 disposed at a position close to the upper side in the up-down direction, and the second displacement unit 460 that is disposed at a position farther away from the lower side in the up-down direction than the first displacement unit 450 and that includes a corner portion between the one end portion 462A and the front end portion 462C. With the configuration, the long recording medium is less likely to be caught by the second displacement unit 460 as compared with a configuration having an end portion that is orthogonal to the recording medium and is configured by only a surface along the recording medium.

Then, the post-processing apparatus 300 according to the present exemplary embodiment includes the aligning unit 400, and the first post-processing unit 15 and the second post-processing unit 90 that process the recording medium aligned by the aligning unit. With the configuration, the recording media may be post-processed in a state of being aligned.

### Configuration of Second Exemplary Embodiment

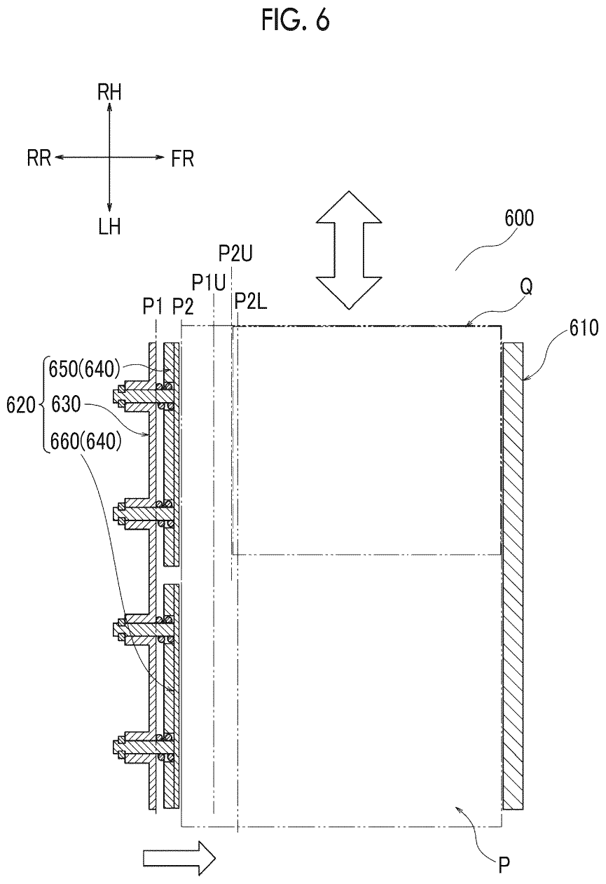

Hereinafter, an example of a second exemplary embodiment of the present disclosure will be described with reference to FIGS. 1 and 6.

The present exemplary embodiment and the first exemplary embodiment have the same basic configuration, but an aligning unit 600 of the present exemplary embodiment has a different attachment position from the aligning unit 400 of the first exemplary embodiment. Specifically, the aligning unit 600 according to the present exemplary embodiment has a configuration (jogger) of tapping and aligning the recording medium on which an image is formed, inside the image forming apparatus 200.

As illustrated in FIG. 6, the aligning unit 600 includes a contact unit 610 and a tapping unit 620. The tapping unit 620 includes an approaching and separation unit 630 and a displacement unit 640 (first displacement unit 650 and second displacement unit 660). These respective constituent units have the same functions as the respective constituent units in the first exemplary embodiment.

In a case where the recording medium P or Q is carried to the left side in the left-right direction (lower side in the up-down direction in the drawing), after the recording medium P or Q is aligned, the aligning unit 600 carries out the recording medium P or Q to the right side in the left-right direction (upper side in the up-down direction in the drawing) by using a reversing mechanism (not illustrated). The reversing mechanism is used, for example, in a case where images are formed on both surfaces of the recording medium P or Q.

### Operation and Effects

The image forming apparatus 200 according to the present exemplary embodiment includes the image forming unit 240 that forms an image, and the aligning unit 600 that aligns the recording medium on which the image is formed by the image forming unit 240. With the configuration, the recording media on which the image is formed are aligned.

### Configuration of Third Exemplary Embodiment

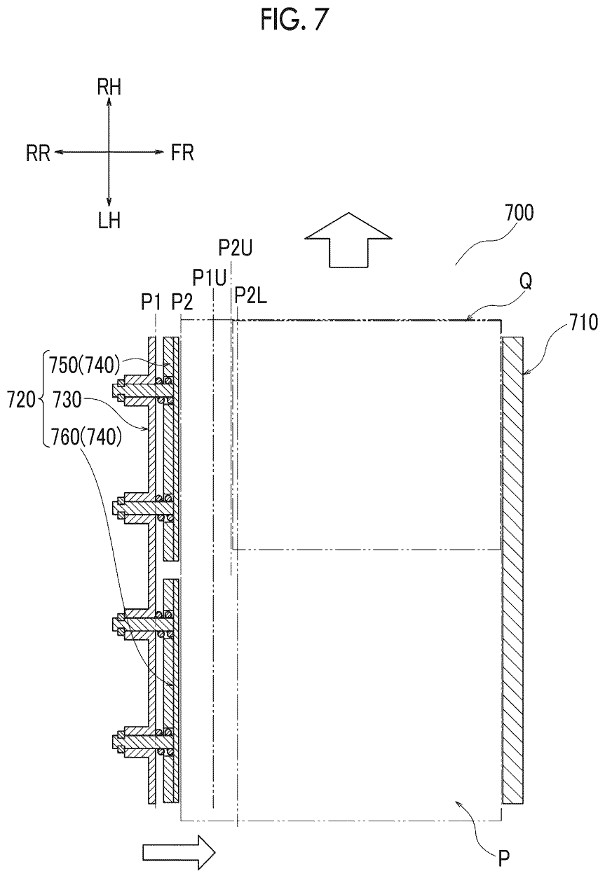

Hereinafter, an example of a third exemplary embodiment of the present disclosure will be described with reference to FIGS. 1 and 7.

The present exemplary embodiment and the first exemplary embodiment have the same basic configuration, but an aligning unit 700 of the present exemplary embodiment has a different attachment position from the aligning unit 400 of the first exemplary embodiment. Specifically, the aligning unit 700 according to the present exemplary embodiment has a configuration (side tamper, side fence) of tapping and aligning the recording medium on which an image is formed, in the discharge unit 260 of the image forming apparatus 200.

As illustrated in FIG. 7, the aligning unit 700 includes a contact unit 710 and a tapping unit 720. The tapping unit 720 includes an approaching and separation unit 730 and a displacement unit 740 (first displacement unit 750 and second displacement unit 760). These respective constituent units have the same functions as the respective constituent units in the first exemplary embodiment.

In a case where the recording medium P or Q on which the image is formed is discharged from the discharge unit 260, the aligning unit 700 aligns the recording medium P or Q by tapping recording medium P or Q. The recording medium P or Q aligned by the aligning unit 700 is discharged from the right side in the left-right direction (upper side in the up-down direction in the drawing) by the discharge unit 260.

### Operation and Effects

The image forming apparatus 200 according to the present exemplary embodiment includes the aligning unit 700 that aligns the recording medium, and the discharge unit 260 that discharges the recording medium aligned by the aligning unit 700. With the configuration, the recording media to be discharged are aligned.

### Modification Example

Although the specific exemplary embodiments of the present disclosure are described in detail, the present disclosure is not limited to such exemplary embodiments, and it is apparent to those skilled in the art that various other exemplary embodiments can be taken within the scope of the present disclosure.

The contact unit 410 is fixed to the panel 402, but the present disclosure is not limited thereto. For example, the contact unit 410 may be supported by the panel 402 to be movable in the front-rear direction. In this case, for example, it is preferable that the contact unit is moved in the front-rear direction by the driving unit 492 in conjunction with the linear motion of the bracket 404 (refer to FIG. 2).

The displacement units extend in the transport direction, and are supported by the approaching and separation unit via the bias units that are disposed at positions shifted from each other in the transport direction.

In the aligning unit 400, the first displacement unit 450 and the second displacement unit 460 extend in the transport direction of the recording medium (the up-down direction in FIG. 3), and are supported by the approaching and separation unit 430 via the coil springs 470 disposed at positions shifted from each other in the transport direction, but the configuration is not required.

In the aligning unit 400, the first displacement unit 450 and the second displacement unit 460 are supported by the common approaching and separation unit 430, but the configuration is not required.

As illustrated in FIG. 2, the approaching and separation unit 430 has the tubular portion 434 formed in a tubular shape extending in the front-rear direction, and the first displacement unit 450 and the second displacement unit 460 have the first rod-like portion 454 inserted into the approaching and separation unit 430 in a state where the first rod-like portion 454 extends to a side separated from the contact unit 410 in the front-rear direction and is attached with the coil spring 470 on the outer periphery, but the configuration is not required.

In the aligning unit 400, the second displacement unit 460 has a taper formed on a corner portion between the one end portion 462A and the front end portion 462C, but the configuration is not required. For example, the taper may be formed in the first displacement unit 450 instead of the second displacement unit 460, or the taper may be formed in both the first displacement unit 450 and the second displacement unit 460. In the first displacement unit 450 and the second displacement unit 460, the taper may not be formed at all.

In the aligning unit 400, the displacement unit 440 has the first displacement unit 450 disposed at a position close to the upper side in the up-down direction, and the second displacement unit 460 that is disposed at a position farther away from the lower side in the up-down direction than the first displacement unit 450 and that includes a corner portion between the one end portion 462A and the front end portion 462C, but the configuration is not required.

In addition, the aligning unit is applied to the post-processing apparatus 300 following the image forming apparatus 200, the inside of the image forming apparatus 200, and the discharge unit 260 in the image forming apparatus 200, but the present disclosure is not limited thereto. The aligning unit may be applied to, for example, the paper feeding unit 220 of the image forming apparatus 200 or a manual paper feeding unit (not illustrated).

The recording medium Q has a shape shorter than the recording medium P in the front-rear direction and the up-down direction, for example, but the present disclosure is not limited thereto. For example, the recording medium Q may have a shape shorter than the recording medium P in any one of the front-rear direction or the up-down direction, or the recording medium Q may be obtained by rotating the orientation of the recording medium P.

### SUPPLEMENTARY NOTE

### (((1)))

A tapping device comprising:
a contact unit that comes into contact with a medium from one side of a crossing direction that crosses a transport direction of the medium;
an approaching and separation unit that approaches and is separated from the contact unit in the crossing direction; and
a displacement unit that is supported by the approaching and separation unit via a bias unit, at each of positions shifted from each other in the transport direction to be displaceable in the crossing direction, and taps the medium in contact with the contact unit from the other side of the crossing direction by the approaching and separation unit approaching the contact unit.

### (((2)))

A tapping device comprising:
a contact unit that comes into contact with a medium from one side of a crossing direction that crosses a transport direction of the medium; and
a tapping unit that taps the medium in contact with the contact unit from the other side of the crossing direction, and has an operation unit that performs a tapping operation and a plurality displacement units each of which is supported by the operation unit via a bias unit to be displaceable in the crossing direction and comes into contact with the medium during the tapping operation, and in which the number of displacement units that come into contact with the medium is different depending on a length in the transport direction.

### (((3)))

The tapping device according to (((1))) or (((2))),
wherein the displacement units extend in the transport direction, and are supported by the approaching and separation unit via bias units disposed at positions shifted from each other in the transport direction.

### (((4)))

The tapping device according to any one of (((1))) to (((3))),
wherein the displacement units are supported by a common approaching and separation unit.

### (((5)))

The tapping device according to any one of (((1))) to (((4))),
wherein the approaching and separation unit has a tubular portion formed in a tubular shape extending in the crossing direction, and
the displacement unit has a shaft that is inserted into the approaching and separation unit in a state where the shaft extends to a side separated from the contact unit in the crossing direction and is attached with the bias unit on an outer periphery.

### (((6)))

The tapping device according to any one of (((1))) to (((5))),
wherein the displacement unit has a taper formed on an end portion on a side in which the medium is carried in the transport direction.

### (((7)))

The tapping device according to any one of (((1))) to (((6))),
wherein the displacement unit has
   a first displacement unit that is disposed at a position close to a side in which the medium is carried in the transport direction, and
   a second displacement unit that is disposed at a position farther away from the side in which the medium is carried than the first displacement unit, and includes an end portion.

### (((8)))

A post-processing apparatus comprising:
the tapping device according to any one of (((1))) to (((7))); and
a processing unit that processes the medium aligned by the tapping device.

### (((9)))

An image forming apparatus comprising:
an image forming unit that forms an image on a medium; and
the tapping device according to any one of (((1))) to (((7))), which aligns the medium on which the image is formed by the image forming unit.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A tapping device comprising:
a contact unit that comes into contact with a medium from one side of a crossing direction that crosses a transport direction of the medium;
an approaching and separation unit that approaches and is separated from the contact unit in the crossing direction; and
a displacement unit that is supported by the approaching and separation unit via a bias unit, at each of positions shifted from each other in the transport direction to be displaceable in the crossing direction, and taps the medium in contact with the contact unit from the other side of the crossing direction by the approaching and separation unit approaching the contact unit.

2. A tapping device comprising:
a contact unit that comes into contact with a medium from one side of a crossing direction that crosses a transport direction of the medium; and
a tapping unit that taps the medium in contact with the contact unit from the other side of the crossing direction, and has an operation unit that performs a tapping operation and a plurality displacement units each of which is supported by the operation unit via a bias unit to be displaceable in the crossing direction and comes into contact with the medium during the tapping operation, and in which the number of displacement units that come into contact with the medium is different depending on a length in the transport direction.

3. The tapping device according to claim 1,
wherein the displacement units extend in the transport direction, and are supported by the approaching and separation unit via bias units disposed at positions shifted from each other in the transport direction.

4. The tapping device according to claim 3,
wherein the displacement units are supported by a common approaching and separation unit.

5. The tapping device according to claim 1,
wherein the approaching and separation unit has a tubular portion formed in a tubular shape extending in the crossing direction, and
the displacement unit has a shaft that is inserted into the approaching and separation unit in a state where the shaft extends to a side separated from the contact unit in the crossing direction and is attached with the bias unit on an outer periphery.

6. The tapping device according to claim 1,
wherein the displacement unit has a taper formed on an end portion on a side in which the medium is carried in the transport direction.

7. The tapping device according to claim 6,
wherein the displacement unit has
a first displacement unit that is disposed at a position close to a side in which the medium is carried in the transport direction, and
a second displacement unit that is disposed at a position farther away from the side in which the medium is carried than the first displacement unit, and includes an end portion.

8. A post-processing apparatus comprising:
the tapping device according to claim 1; and
a processing unit that processes the medium aligned by the tapping device.

9. An image forming apparatus comprising:
an image forming unit that forms an image on a medium; and
the tapping device according to claim 1, which aligns the medium on which the image is formed by the image forming unit.

10. An image forming apparatus comprising:
an image forming unit that forms an image on a medium; and
the tapping device according to claim 2, which aligns the medium on which the image is formed by the image forming unit.

11. An image forming apparatus comprising:
an image forming unit that forms an image on a medium; and
the tapping device according to claim 3, which aligns the medium on which the image is formed by the image forming unit.

12. An image forming apparatus comprising:
an image forming unit that forms an image on a medium; and
the tapping device according to claim 4, which aligns the medium on which the image is formed by the image forming unit.

13. An image forming apparatus comprising:
an image forming unit that forms an image on a medium; and
the tapping device according to claim 5, which aligns the medium on which the image is formed by the image forming unit.

14. An image forming apparatus comprising:
an image forming unit that forms an image on a medium; and
the tapping device according to claim 6, which aligns the medium on which the image is formed by the image forming unit.

15. An image forming apparatus comprising:
an image forming unit that forms an image on a medium; and
the tapping device according to claim 7, which aligns the medium on which the image is formed by the image forming unit.
